(19) United States
(12) Patent Application Publication
(10) Pub. No.: US 2017/0307642 A1
(43) Pub. Date: Oct. 26, 2017

(54) AUTOMATIC CAP-DECAP MECHANISM FOR REAGENT BOTTLES

(71) Applicant: ALTERGON ITALIA S.R.L., Pietradefusi (AV) (IT)

(72) Inventors: Chao YU, Shanghai (CN); Shenguang SU, Shenzhen (CN); Qingwen TANG, Putian (CN); Luca MELILLO, Lion (AV) (IT)

(21) Appl. No.: 15/512,909

(22) PCT Filed: Sep. 22, 2015
(86) PCT No.: PCT/IB2015/057294

§ 371 Date: Mar. 21, 2017

(30) Foreign Application Priority Data
Sep. 22, 2014 (CN) 201410489712.4

(51) Int. Cl. G01N 35/04; B67B 7/00; B67B 3/22; B01L 3/00; G01N 35/00

(52) U.S. Cl. CPC G01N 35/04; B67B 3/22; B01L 3/508; B67B 7/00; B01L 2200/025; B01L 2300/042; G01N 2035/00287; G01N 2035/0405

(57) ABSTRACT

The present invention relates to an automatic cap-decap mechanism for reagent bottles of an immunoanalyzer apparatus, comprising a decap mechanism (100) and a cap mechanism (200) in reagent station (1) of the immunoanalyzer apparatus; the decap mechanism (100) and the cap mechanism (200) are both configured for operating on a cap of a reagent bottle (2). The cap comprises a hinge-shaped plate cap (5), a snap joint (4) and a decap spring (6); one side of the hinge-shaped plate cap (5) is hinged on the reagent bottle mouth, and the other side of the hinge-shaped plate cap (5) comprises the snap joint (4); the snap joint (4) is configured for tightly clamping the hinge-shaped plate cap (5) on the reagent bottle mouth; one end of the decap spring (6) is mounted on a holding structure of the reagent bottle, and the other end of the decap spring (6) connects to a hinge pin of the hinge-shaped plate cap (5), so that when the snap joint (4) is not snapped in close position, the decap spring (6) is configured to move the hinge-shaped plate cap (5) so as to expose the bottle mouth in decap condition.

The decap mechanism (100) comprises: a first roller seat (104) located at the upper part of the reagent bottle (2), and a rotating rod (108) horizontally inserted into the roller bearings provided on the first roller seat (104), a first motor (103) for timely driving the rotating rod (108), and at least one first ejection rod (109) driven by the rotating rod (108) to move upward and downward; the first ejection rod (109) is configured for snapping the snap joint (4) in open position, so as to decap the reagent bottle (2).

The cap mechanism (200) comprises: a rocker (210) rotatably installed on the roller bearings of a rocker holder (209), and a knockout plate (204) connected on one end of the rocker (210); the knockout plate (204) comprises an electric magnet (203); the cap mechanism (200) further comprises at least one roller baffle (211) connected on the other end of the rocker (210), the roller baffle (211) comprising a roller (11) at the bottom, the knockout plate (204) being configured for acting on the rocker (210) under the action of a spring when the electric magnet (203) is not powered, so as to maintain the roller (11) of the roller baffle (211) on the hinge-shaped plate cap (5); the roller (11) is configured for snapping the snap joint (4) in close position, so as to cap the reagent bottle (2).

The present invention also relates to an immunoanalyzer apparatus and a regent bottle (2).

### TECHNICAL FIELD OF THE INVENTION

The present invention relates to an automatic cap-decap mechanism for reagent bottles, to an immunoanalyzer apparatus, and to a reagent bottle for an immunoanalyzer apparatus.

### BACKGROUND ART

An immunoassay is a biochemical test that measures the presence or concentration of a macromolecule in a solution through the use of an antibody and/or antigen. The macromolecule (often defined “analyte”) detected by the immunoassay is in many cases a protein. “Analytes” in biological liquids are frequently measured using immunoassays for medical and research purposes.

Immunoassays may be performed by an apparatus defined as “immunoanalyzer”; such apparatus may carry multiple steps with one or more reagents being added and/or washed away or separated at different points in the assay.

At present, to reduce evaporation of the reagents, an automatic immunoanalyzer is designed for reagent bottles or vials which comprise a cap. The cap is open (“decap”) to get access to the reagent, and the cap it is subsequently closed (“cap”). Therefore, a corresponding mechanism is needed to achieve automatic cap-decap.

An immunoanalyzer usually comprises refrigeration of the reagent stations, to maintain the reagent compartment at controlled temperature. Such immunoanalyzer requires a further door opening and closing mechanism for the refrigerated reagent station.

However, the mechanism to achieve cap-decap action in a refrigerated reagent station may have a complicated structure and require more time and energy for the cap-decap action. Therefore there is a need for a mechanism which achieves reagent bottle cap-decap action in a closed reagent station of the refrigerated type.

Such automatic cap-decap mechanism for reagent bottles will benefit from a higher efficiency of the module operation, a more stable and reliable handling of the reagent bottles and the reagent thereof, and require less complicated mechanisms. Meanwhile, energy efficiency and emission reduction can also be achieved.

### SUMMARY OF THE INVENTION

It is a main object of the present invention to provide an automatic cap-decap mechanism for reagent bottles which overcomes the above problems and drawbacks.

A further object of the present invention is an immunoanalyzer apparatus which comprises an automatic cap-decap mechanism for reagent bottles.

A further object of the present invention is a reagent bottle for an immunoanalyzer apparatus which comprises an automatic cap-decap mechanism.

It is a particular object of the present invention an automatic cap-decap mechanism for reagent bottles, as described in the attached claims, which are considered an integral part of the present description.

According to the invention, it is provided an automatic cap-decap mechanism for reagent bottles of an immunoanalyzer apparatus, comprising a decap mechanism and a cap mechanism in reagent station of the immunoanalyzer apparatus; the decap mechanism and the cap mechanism are both configured for operating on a cap of a reagent bottle.

The cap comprises a hinge-shaped plate cap, a snap joint and a decap spring; one side of the hinge-shaped plate cap is hinged on the reagent bottle mouth, and the other side of the hinge-shaped plate cap comprises the snap joint; the snap joint is configured for tightly clamping the hinge-shaped plate cap on the reagent bottle mouth; one end of the decap spring is mounted on a holding structure of the reagent bottle, and the other end of the decap spring connects to a hinge pin of the hinge-shaped plate cap, so that when the snap joint is not snapped in close position, the decap spring is configured to move the hinge-shaped plate cap so as to expose the bottle mouth in decap condition.

The decap mechanism comprises: a first roller seat located at the upper part of the reagent bottle, a rotating rod horizontally inserted into the roller bearings provided on the first roller seat, a first motor for timely driving the rotating rod, and at least one first ejection rod driven by the rotating rod to move upward and downward; the first ejection rod is configured for snapping the snap joint in open position, so as to decap the reagent bottle.

The cap mechanism comprises: a rocker rotatably installed on the roller bearings of a rocker holder and a knockout plate connected on one end of the rocker; the knockout plate comprises an electric magnet; the cap mechanism further comprises at least one roller baffle connected on the other end of the rocker, the roller baffle comprising a roller at the bottom, the knockout plate being configured for acting on the rocker under the action of a spring when the electric magnet is not powered, so as to maintain the roller of the roller baffle on the hinge-shaped plate cap; the roller is configured for snapping the snap joint in close position, so as to cap the reagent bottle.

Advantageously, the automatic cap-decap mechanism for reagent bottles overcomes inconveniences caused by reagent bottle cap-decap operations.

The automatic cap-decap mechanism for reagent bottles prevents the reagent from cross-contamination, keeping the reagent more stable and reliable, and ensuring a highly efficient operation of the immunoanalyzer apparatus.

The automatic cap-decap mechanism for reagent bottles applies a step motor to drive the timing belt for transmission, a gear rack transmission to provide cap-decap action, and an electric magnet which drives the rocker to achieve cap-decap action.

The automatic cap-decap mechanism makes the equipment more simple and stable. Meanwhile, integration of the automatic cap-decap mechanism within a reagent station provides the advantage of an effective refrigeration maintained in the reagent station.

The automatic cap-decap mechanism provides the advantage of a full use of the room available in the reagent station,

The automatic cap-decap mechanism provides the advantage of no longer requiring complicated mechanical structures; the automatic cap-decap mechanism features a simpler and more stable structure.

The automatic cap-decap mechanism provides the advantage of reducing reagent's evaporation, and improving stability of the reagent which are less exposed to external influences.

The integration of the reagent station and of the automatic cap-decap mechanism makes the modular structure of the immunoanalyzer apparatus more simple and compact.

The automatic cap-decap mechanism provides the advantage that work efficiency is also improved.

In addition, in a closed reagent station, the automatic cap-decap mechanism will optimize energy conservation and efficiency, so that an easier and more reliable temperature control can be achieved.

Moreover, by assembling the automatic cap-decap mechanism with the reagent station, the reagent station can effectively maintain the refrigeration effect, and no additional complicated mechanical structures are required; in this way, the room available in the reagent station is fully exploited.

The automatic cap-decap mechanism comprises a bumper block which can effectively slow down the decap speed, to prevent the reagent bottle from decapping at excessively high speed, causing any reagent remained on the cap to splash, so as to prevent pollution and harm.

The automatic cap-decap mechanism comprises an advantageous close test device on the bottle cap, to perform real time test on the closed/open state of bottle cap; in this way, the accuracy of operation can be increased, by timely sending signals, performing the tests more quickly, and lowering failure rate.

### BRIEF DESCRIPTION OF THE DRAWINGS

The invention will become fully clear from the following detailed description, given by way of a mere exemplifying and non-limiting example, also with reference to the attached drawing figures, wherein:

FIG. 1 is a structure illustration of the cap-decap mechanism for reagent bottles of a reagent station according to the present invention;

FIG. 2 is a top view of the cap-decap mechanism for reagent bottles and of the reagent station of FIG. 1;

FIG. 3 is a side view of the cap-decap mechanism for reagent bottles and of the reagent station of FIG. 1;

FIG. 4 is an illustration of a reagent bottle and snap joint used configured for matching according to the present invention;

FIG. 5 is an illustration of the structure of the decap mechanism for reagent bottles according to the present invention;

FIG. 6 is a partially sectioned top view of the decap mechanism for reagent bottles of FIG. 5;

FIG. 7 is an illustration of a first embodiment of the decapping process of a reagent bottle in a cap-decap mechanism according to the present invention;

FIG. 8 is an illustration of a second embodiment of the decapping process of a reagent bottle in a cap-decap mechanism according to the present invention;

FIG. 9 is an illustration of the structure of the cap mechanism for reagent bottles according to the present invention;

FIG. 10 is a partial side view of the cap mechanism for reagent bottles of FIG. 9;

FIG. 11 is an illustration of the cap mechanism for reagent bottles according to the present invention, when the roller of the roller plate is in a high position;

FIG. 12 is an illustration of the cap mechanism for reagent bottles according to the present invention, when the roller of the roller plate is in a low position;

FIG. 13 is an illustration of the structure of a cap detection device of the cap mechanism according to the present invention;

FIG. 14 is a partially sectioned view of the top part of the cap detection device of the cap mechanism according to the present invention;

FIG. 15 is an illustration of the process for capping a second reagent bottle with the cap mechanism of the present invention;

FIG. 16 is an illustration of the process for cap detection by means of the detection device of the cap mechanism according to the present invention, wherein the cap fails in capping;

FIG. 17 is back view of the close capping inducer of the cap close detection device according to the present invention.

The same reference numerals and letters in the figures designate the same or functionally equivalent parts or elements.

### DETAILED DESCRIPTION OF THE PREFERRED EMBODIMENTS

In the framework of the present description, the automatic cap-decap mechanism for reagent bottles according to the present invention is applicable to an immunoanalyzer apparatus.

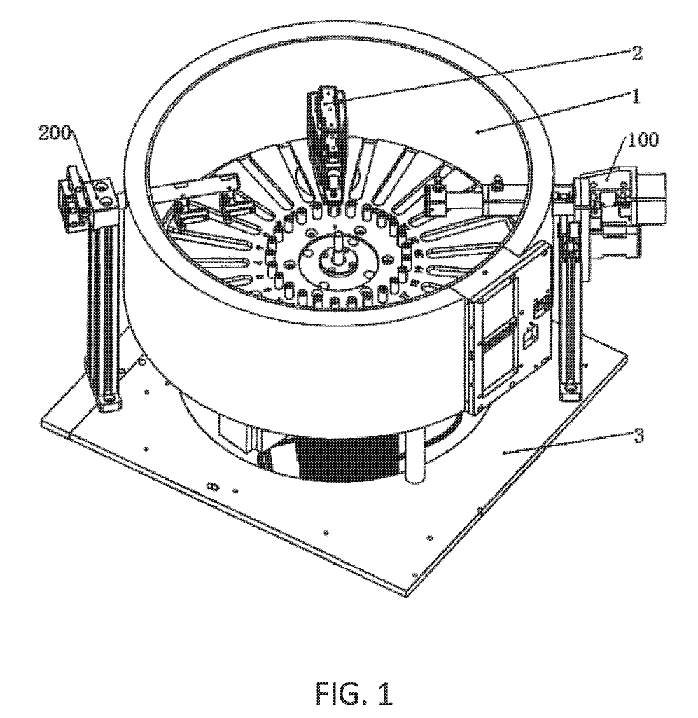

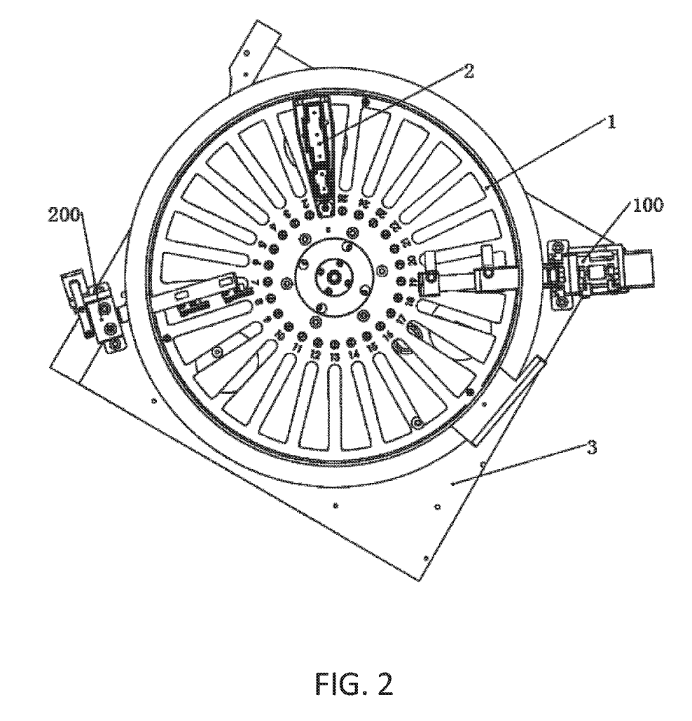

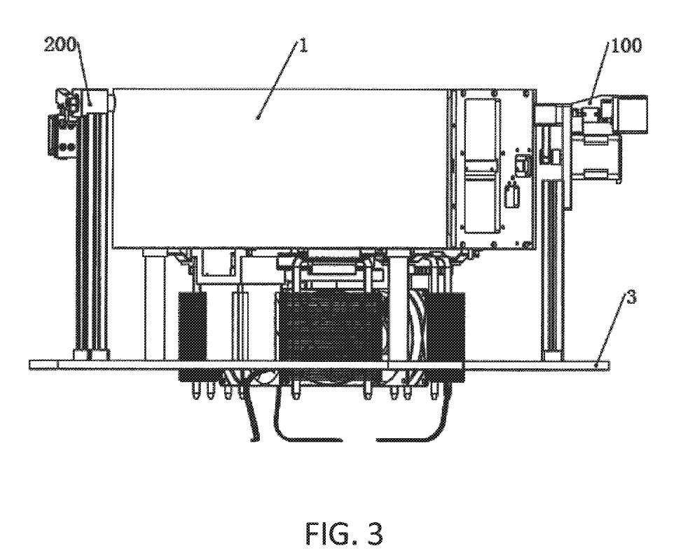

The integrated structure of the automatic cap-decap mechanism within a reagent station according to the present invention is shown in FIG. 1, FIG. 2 and FIG. 3.

FIG. 1 is illustrates the structure of the cap-decap mechanism for reagent bottles integrated within a reagent station. The automatic cap-decap mechanism for reagent bottles comprises a decap mechanism 100 and a cap mechanism 200. The decap mechanism 100 and the cap mechanism 200 on the reagent station 1, automatically cap and decap the reagent bottle 2. The reagent station 1 comprises a base 3. FIG. 2 is a top view of the reagent station 1. FIG. 3 is a side view of the cap reagent station 1.

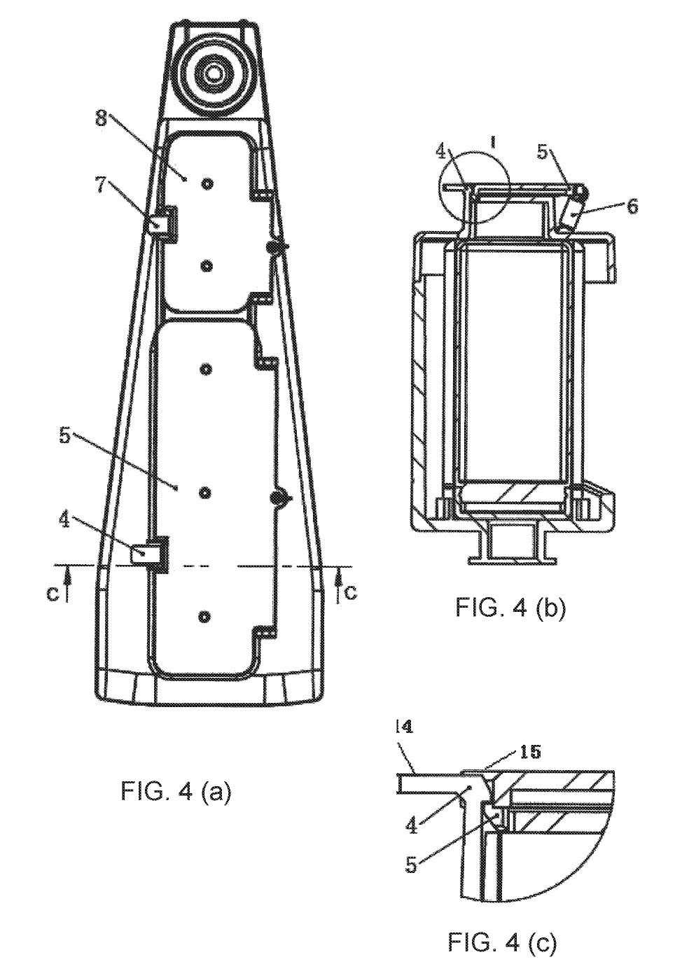

FIG. 4 is an illustration of a reagent bottle and a snap joint, which are meant to cooperate and match. Subfigure (a) is an illustration of the complete structure, subfigure (b) is a section view along line C-C of subfigure (a), and subfigure (c) is a magnified view of the circled area of subfigure (b).

As shown in FIG. 4, for each snap position of the reagent station, two reagent bottles are provided. A first reagent bottle cap comprises of first hinge-shaped plate cap 5, a first snap joint 4 and a first decap spring 6; a second reagent bottle cap consists of second hinge-shaped plate cap 8, a second snap joint 7 and a second decap spring.

The first hinge-shaped plate cap 5 is fixed at one side of the reagent bottle mouth. One side of the plate cap 5 is hinged, while the other side is connected to the first snap joint 4, which is used for snapping the moveable plate tightly onto the mouth of the reagent bottle.

The upper part of the snap joint is equipped with a snap protruding flange 14 which stretches outwards.

One end of the decap spring 6 is mounted on a holding structure of the reagent bottle, and the other end connects to a hinge pin of the hinge-shaped plate cap 5. When the snap joint 4 is not snapped, the spring makes the moveable plate turning outward, so as to completely expose the bottle mouth in decap condition.

The holding structure of the reagent bottle is a frame-like structure which contains and holds at least one, preferably two reagent vials each one respectively closeable by the first hinge-shaped plate cap 5 and the second hinge-shaped plate cap 8.

A side part of the moveable plate is equipped with a bottle cap protruding flange 15. When the snap joint snaps, the bottle protruding flange 15 covers and seals the snap joint 4.

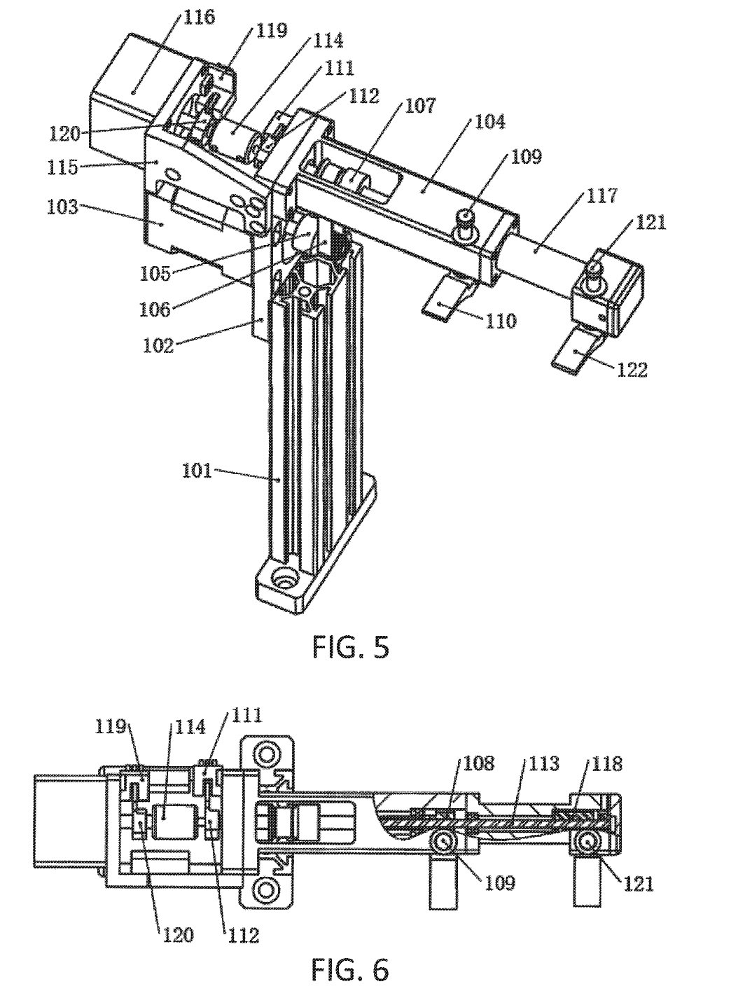

FIG. 5 is an illustration of the structure of the decap mechanism for reagent bottles according to the present invention.

FIG. 6 is a sectioned top view of part of the decap mechanism 100 for reagent bottles.

As shown in FIG. 5 and FIG. 6, the decap mechanism 100 comprises a supporting plate 102, a first motor 103, a first roller holder 104, a first timing pulley 105, a timing belt 106, a second timing pulley 107, a spindle 108 and a first ejection rod 109. The decap mechanism 100 is also supported on a base 3 of the reagent station 1 by the fixation base 101.

The first roller holder 104 is installed inside the reagent station 1 and is located at the upper part of the reagent bottle.

The first motor 103, the first roller holder 104, the first timing pulley 105, the timing belt 106, the second timing pulley 107, the spindle 108 and the first ejection rod 109 are all installed on the supporting plate 102, and the supporting plate 102 is in turn installed on the fixation base 101.

The spindle 108 is horizontally inserted into the bearing provided on the first roller holder 104, the spindle 108 is further equipped with a first gear for the second timing pulley 107. The first motor 103 drives the first timing pulley 105 to rotate, the first timing belt 105 connects to the second timing pulley 107 with the timing belt 106 as transmission; the first ejection rod 109 is fixed with a first rack, and the first gear meshes with the first roller holder 104 in vertical direction.

The first motor drives the driving unit to move the spindle 108 which rotates with the timing belt; the spindle 108 is equipped with a first gear, and the first gear drives the first ejection rod 109 to move upward and downward.

By controlling rotation of the first motor 103, by means of the transmission of the timing belt and gear rack, the first ejection rod moves upward and downward.

The first ejection rod 109 moves downward to engage the protruding flange of the snap joint to complete the decap action.

When the first ejection rod 109 ejects the snap joint 4 of the reagent bottle 2 to decapped position, due to the extraction force of the decap spring 6, the bottle cap 5 of the reagent bottle 2 is decapped; the first ejection rod 109 moves upward to complete the action of reset.

The decap mechanism 100 further comprises a first bumper block 110 equipped at one end of the first ejection rod 109. The first bumper block 110 is provided to prevent the reagent bottle to be decapped at excessively high speed, which would cause the reagent which may be remained on the cap to splash and thus pollute or harm the surroundings.

The decap mechanism 100 further comprises a first optical coupling sensor 111 provided on the supporting base 102 and a first sensor 112 fixed on the spindle 108. During the rolling of the spindle 108, when the first sensor 112 passes through the first optical coupling sensor, it blocks the light path of the first optical coupling sensor to trigger a coupling signal. By this arrangement, the lowering position of the ejection rod can be accurately controlled, meaning that the contact height of the ejection rod and of the reagent bottle cap is also controlled.

The rocker holder of the cap mechanism is provided also with a limit pin 208, which is located under the rocker 204. The limit pin 208 can prevent overly large spring forces from continuously stressing the push head 10 of the electric magnet 203.

The decap mechanism further comprises an internal shaft 113, a coupler 114, a motor stand 115, a second motor 116, a second roller holder 117, a second gear 118 and a second ejection rod 121. The roller holder 117 connects to the first roller holder 104. The second motor 116 is installed on the motor stand 115 fixed on the supporting plate 102. The motor shaft of the second motor 116 connects to one end of the internal shaft 113 by means of the coupler 114. The other end of the internal shaft 113 matches with the bearings of the second roller holder 117 and passes through the hollow spindle 108, so as to fix the internal shaft 113 with the second gear 118.

The second ejection rod 121 is fixed with the second rack, and is installed on one end of the second gear 118, with gear meshing. When the reagent bottle cap rotates along the reagent station, and when the snap joint protruding flange of the reagent bottle cap in the reagent station is located right under the second ejection rod, the ejection rod moves to complete decapping.

The second motor 116 drives the internal shaft 113 with the coupler 114. The second gear 118 equipped on the internal shaft 113 drives the second rack of the second ejection rod 121, thus driving the ejection rod 121 upward and downward. Along with control of the motor, the second ejection rod can separately complete decapping of another reagent bottle located at the same radial position of the first reagent bottle; the decap actions on the two reagent bottles are thus non-interfering with each other.

The decap mechanism further comprises a second optical coupling sensor 119 equipped on the supporting base 102, and a second sensor 120 fixed on the axis of the coupler 114. During rotation of the coupler 114, the second sensor blocks second optical coupling sensor 119 to trigger a further coupling signal.

The decap mechanism further comprises a second bumper block 122 equipped on one end of second ejection rod 121.

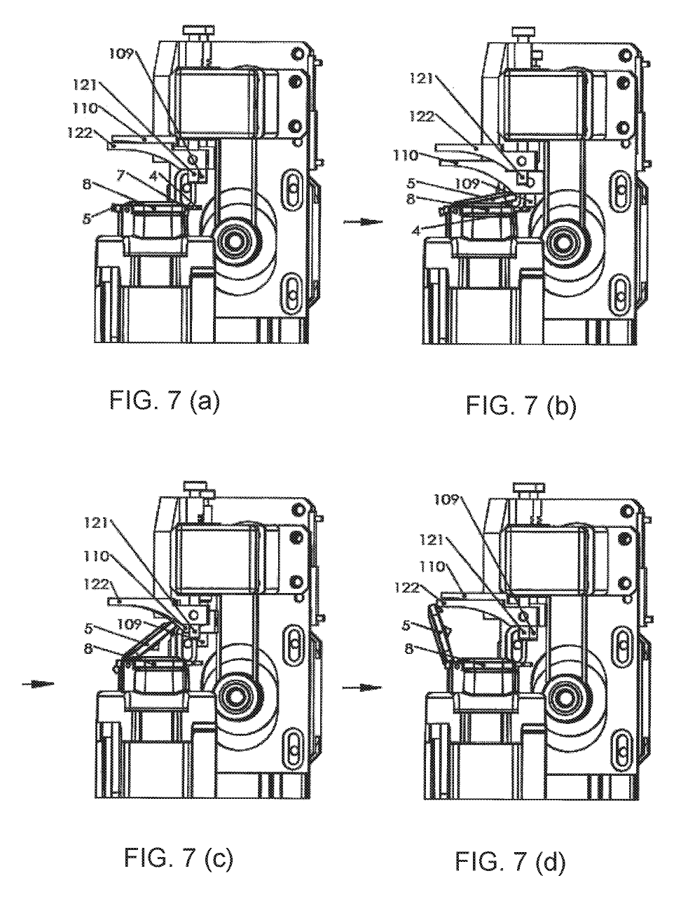

FIG. 7 illustrates the decapping process of a first reagent bottle; subfigure (a) shows that a first ejection rod moves on the first snap joint; subfigure (b) shows that a first ejection rod moves downward to ejection and presses a first snap joint, and a first hinge-shaped plate cap separates from first snap joint; subfigure (c) shows that a first ejection rod moves upward, and a first bumper block contacts with first hinge-shaped plate cap; subfigure (d) shows that a first ejection rod moves upward to go back to its initial position, and a first hinge-shaped plate cap is entirely decapped.

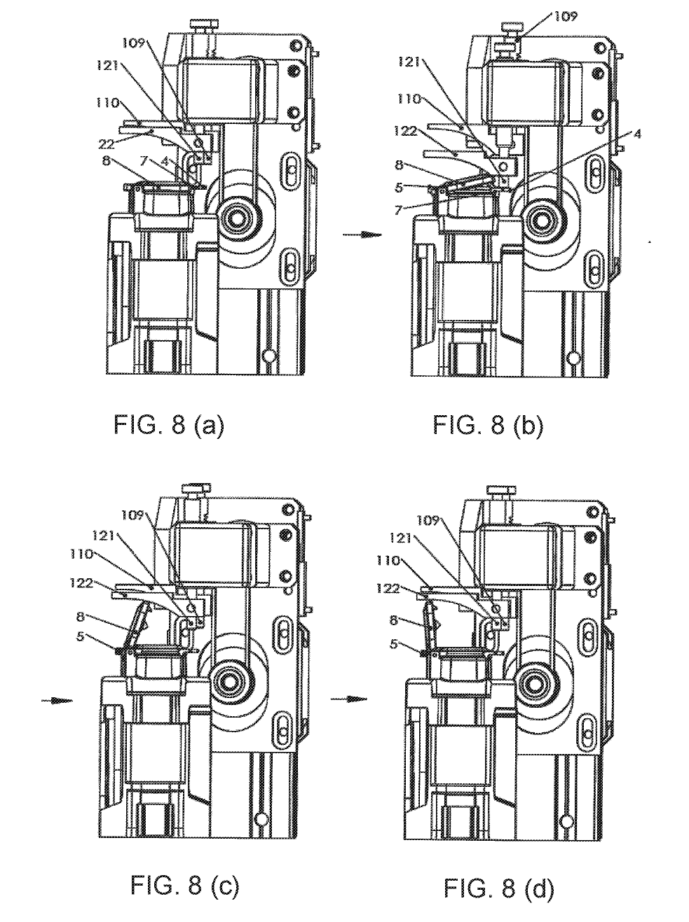

FIG. 8 illustrates the decapping process of a second reagent bottle; subfigure (a) shows that a second ejection rod moves on the second snap joint; subfigure (b) shows that a second ejection rod moves downward to ejection and presses a second snap joint, and a second hinge-shaped plate cap separates from the second snap joint; subfigure (c) shows that a second ejection rod moves upward, and a second bumper block contacts with a second hinge-shaped plate cap; subfigure (d) shows that a second ejection rod moves upward to go back to its initial position, and a second hinge-shaped plate cap is entirely decapped.

The first ejection rod is configured for snapping the snap joint in open position, so as to decap the first hinge-shaped plate cap of the reagent bottle. The second ejection rod is configured for snapping a second snap joint in open position, so as to decap the second hinge-shaped plate cap of the reagent bottle.

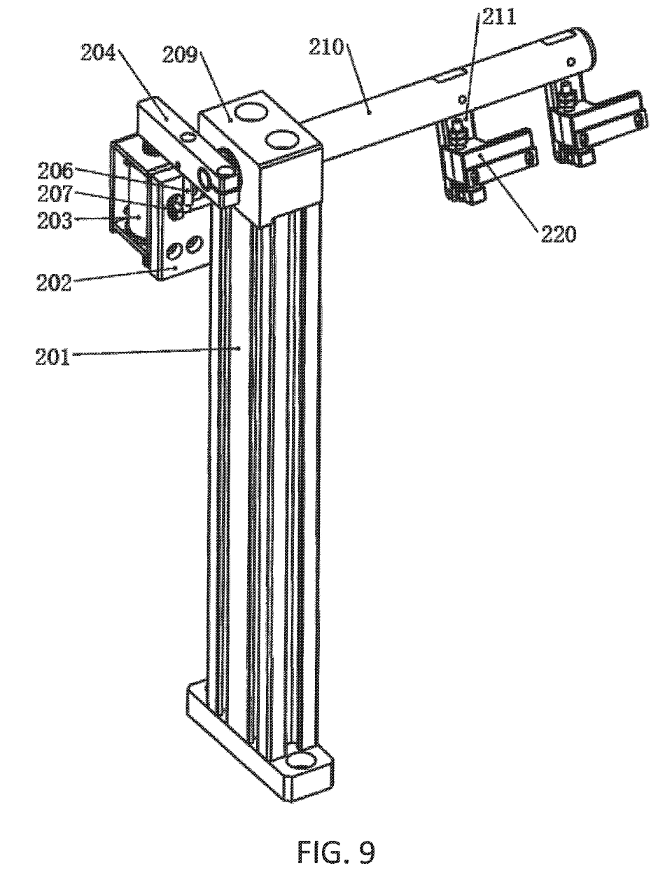

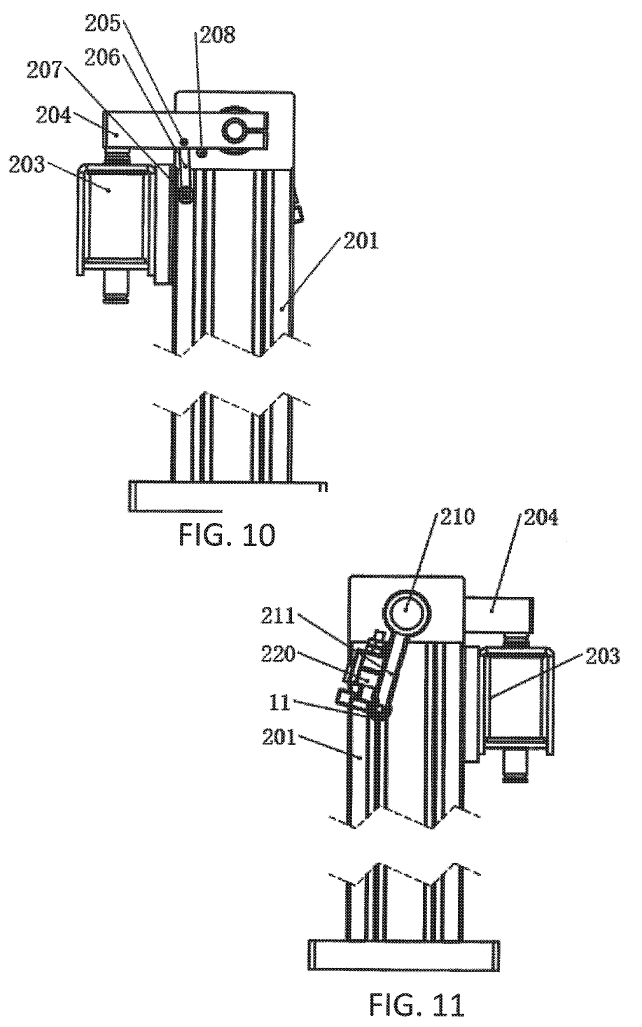

FIG. 9 illustrates the structure of the cap mechanism for the reagent bottles, and FIG. 10 is a side view of the cap mechanism for the reagent bottles.

As shown in FIG. 9 and FIG. 10, the cap mechanism 200 comprises an electric magnet installation seat 202, an electric magnet 203, a pusher 204, a puller 205, an extension spring 206, a pop-rivet 207, a limit pin 208, a rocker holder 209, a rocker 210 and a roller baffle 211. The cap mechanism 200 is fixed on the base 3 of the reagent station 1 by the supporting base 201.

The rocker holder 209 is fixed on the supporting base 201. The rocker 210 is installed by matching with the bearing on the rocker holder 209; the electric magnet installation seat 202 is fixed on the supporting base 201, and the electric magnet 203 is installed in the electric magnet installation seat (202). The knockout plate 204 and one end of the rocker 210 are connected together; the other end of the rocker 210 is equipped with the roller baffle 211, and the roller baffle 211 is equipped with roller 11 at the bottom.

A drag hook on one end of the extension spring 206 connects to the puller 205 which is fixed on the knockout plate 204. Another drag hook on the other end connects to the pop-rivet 207 fixed on the supporting base 201. When no power circulates through to the electric magnet, the knockout plate 204 falls on the push head 10 of the electric magnet due to the action of the extension spring, and thus maintains the roller baffle on the reagent bottle cap.

When the cap mechanism is not active, the electric magnet 203 is not connected to the power. With the pulling force from the extension spring 206, the roller baffle 211 is kept at high position and does not come in contact with the cap of the reagent bottle, as shown in FIG. 11.

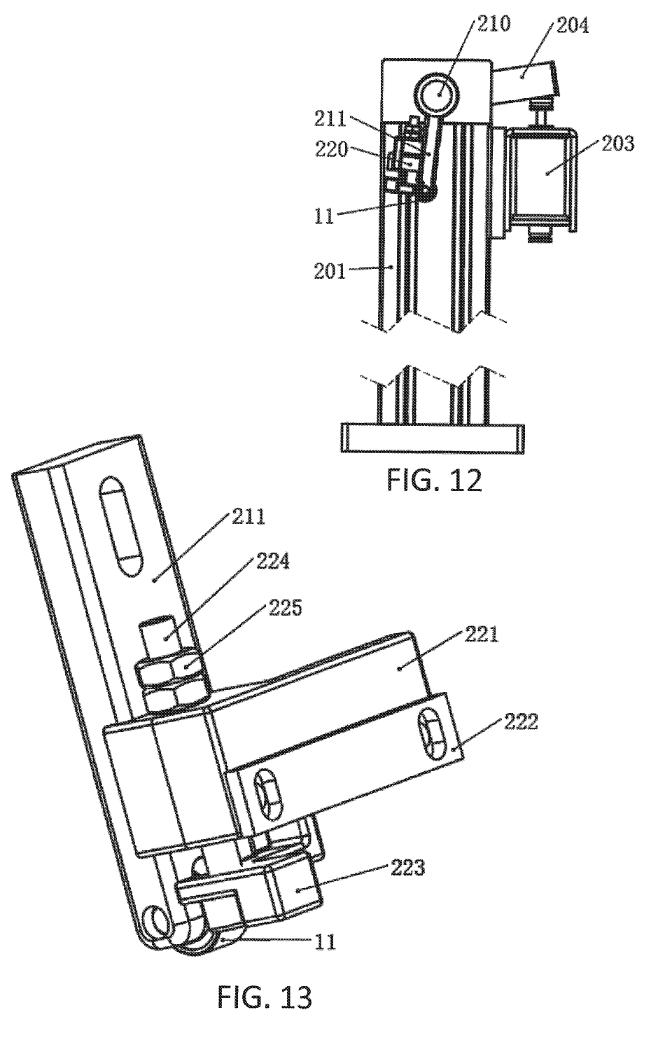

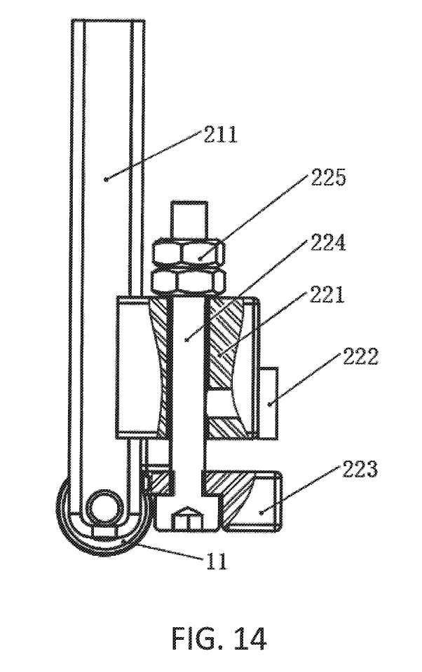

FIG. 11 illustrates when the roller of the roller plate is at a high position; FIG. 12 illustrates when the roller of the roller plate is at a low position; FIG. 13 illustrates the cap detection device; FIG. 14 is a section and top view of part of the cap detection device.

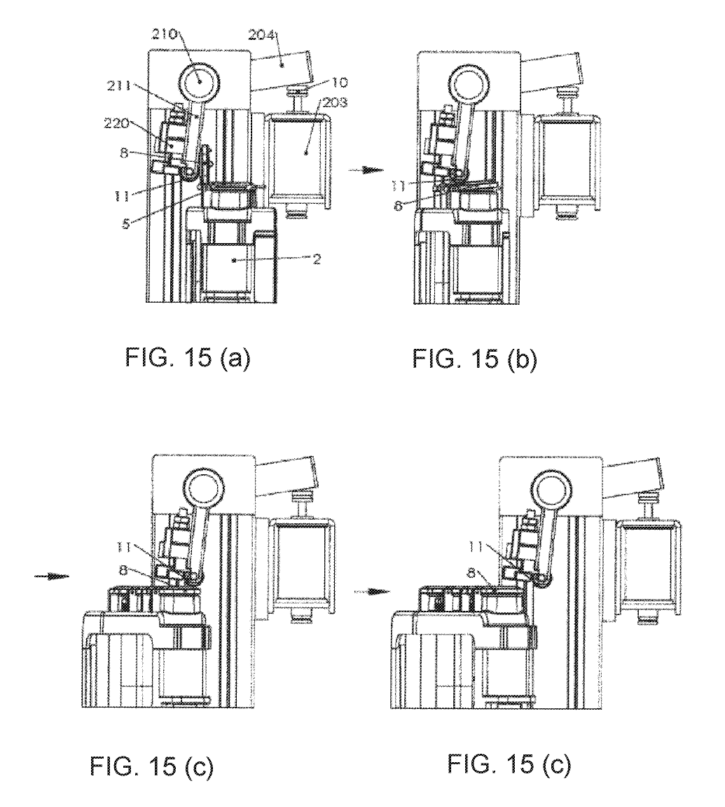

The whole cap process of a second reagent bottle is shown in FIG. 15; subfigure (a) shows that the roller baffle moves to the low position of the second reagent bottle cap, ready to decap; subfigure (b) shows rolling and pressing of the roller along a surface of the second hinge-shaped plate cap; subfigure (c) shows that the roller makes the second hinge-shaped plate cover snap with the second snap joint, and the cap is capped; subfigure (d) shows that the roller leaves from the second hinge-shaped plate cap, and returns to the high position.

When performing the cap action, before reaching the reagent bottle 2, the electric magnet 203 is connected to the power and the push head 10 overcomes the pulling force from the extension spring 206 to push the knockout plate 204 for putting the rocker 210 in rotation. The rocker 210 drives the roller baffle 211 to the lowest position, meaning the position wherein the reagent bottle 2 is capped. When the capped reagent bottle 2 passes through, the cap of the reagent bottle 2 is blocked by the rocker baffle 211 and makes the snap joint snap due to rolling depression of the roller 11, so as to cap the bottle. In fact, the roller 11 is configured for snapping the snap joint in close position, so as to cap the reagent bottle 2.

As shown in FIG. 13 and FIG. 14, the cap mechanism further comprises a bottle cap close test device 220. The bottle cap close test device 220 is fixed on the roller baffle 211 with the close capping optical coupling sensor fixation base 221.

The cap mechanism further comprises a close capping optical coupling sensor 222, a close capping inducer 223, a guide rod 224 and a screw nut 225.

The close capping optical coupling sensor 222 is fixed on the close capping optical coupling sensor fixation base 221. The close capping optical coupling sensor fixation base 221 comprises vertical holes; the guide rod 224 passes through these holes. The upper part of the guide rod comprises two limit screw nuts 225, whose the lower parts are connected to close capping inducer 223. The close capping inducer guide rod 224 moves upward and downward.

When the guide rod 224 is lift upward to the highest position, the close capping inducer 223 stretches into the close capping optical coupling sensor 222 to block the light path; when the guide rod is not lifted up, the close capping inducer 223 is located outside the close capping optical coupling sensor 222, and the light path of the close capping optical coupling sensor is not blocked.

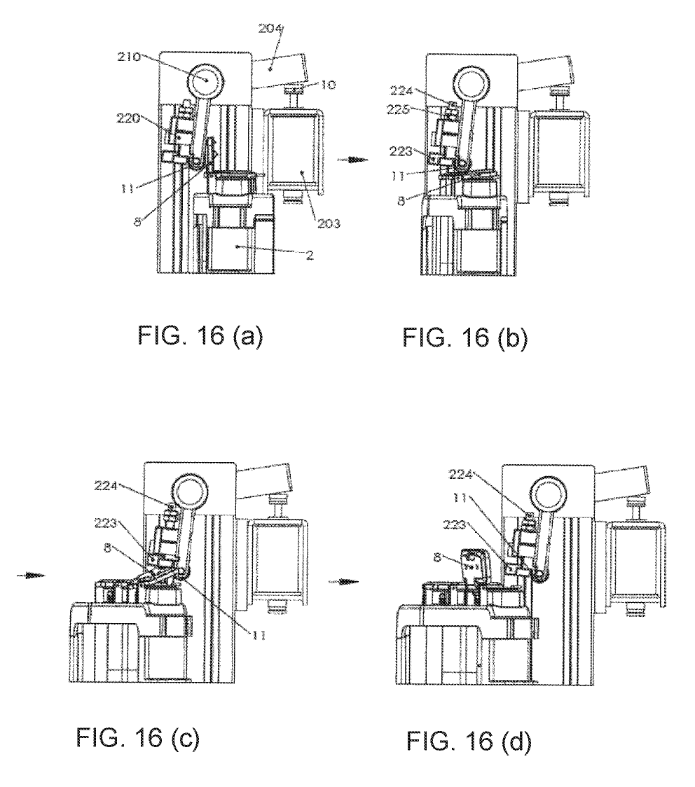

FIG. 16 illustrates the detection process for the cap detection device, when it is detected that the cap fails in capping; subfigure (a) shows that the roller baffle moves to the low position of a second reagent bottle cap ready to decap; subfigure (b) shows rolling and pressing of the roller along surface of the second hinge-shaped plate cap; subfigure (c) shows that the uncapped second hinge-shaped plate cover lifts up the close capping inducer to block the light path of the optical coupling sensor to trigger the signal, and detects that the cap is not capped; subfigure (d) shows that the reagent bottle goes on turning, the uncapped second hinge-shaped plate cap does not contact the close capping inducer any more, and the close capping inducer returns to its former initial position due to its weight and does not block the optical coupling sensor.

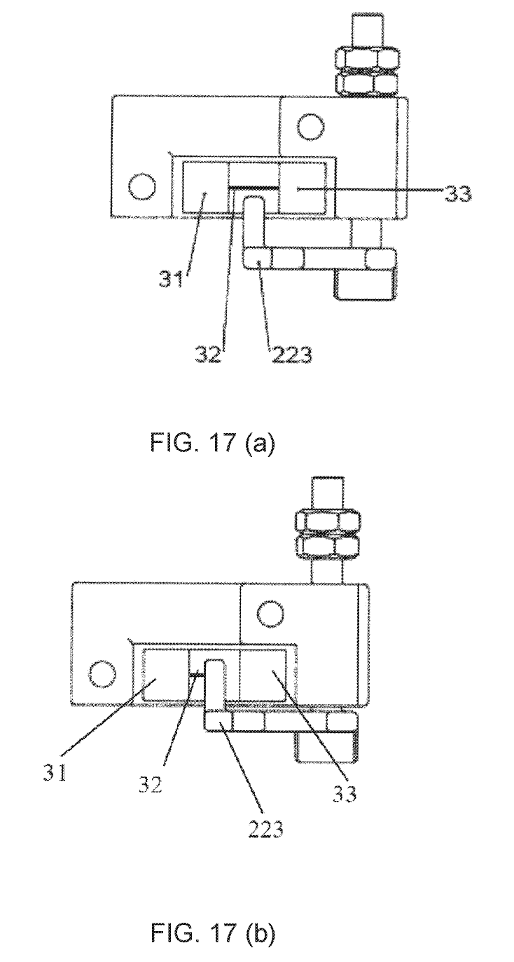

In case the bottle cap is not correctly capped, the uncapped bottle cap lifts up the close capping inducer 223 to block the light path of the close capping optical coupling sensor 222. As it will be described with reference to subfigure (b) of FIG. 17, the signal is triggered; when the bottle keeps going on, due to weight of the inducer 223, it retunes to the low position, and it separates from the close capping optical coupling sensor 222. By receiving the signal from the close capping optical coupling sensor 222, it is recognized if the bottle cap is correctly capped or not, to ensure a safe and reliable use of the machine.

FIG. 17 is a back view of the close capping inducer, when the cap close detection device is not lifted up; subfigure (a) shows that the close capping inducer 223 is not lifted up; the close capping inducer 223 does not block the close capping optical coupling sensor 222, meaning that the light path 32 formed by light and wave emitted from the light wave emitter 31 and received light and wave receiver is not blocked, and the signal is not triggered.

Instead, subfigure (b) shows that the close capping inducer is lifted up 223. When capping is not needed for the bottle cap, it is detected by the close capping detection device 220 of the cap mechanism 200, and the close capping inducer 223 shall be at low position.

According to an aspect of the present invention, it is provided an automatic cap-decap mechanism for reagent bottles which comprises a decap mechanism 100 and a cap mechanism 200. With the decap mechanism 100 and cap mechanism 200 on the reagent station 1, it is possible to automatically cap and decap the reagent bottle 2.

Preferably, the reagent bottle cap comprises a of hinge-shaped plate cap 5, a snap joint 4 and a decap spring 6; the hinge-shaped plate cap 5 is fixed on one side of the reagent bottle mouth. One side of a moveable plate is hinged, and the other side is equipped with a flapping point for the snap joint; by flapping of the snap joint 4, the flapping point of the snap joint 4 clamps tightly with the hinge-shaped plate cap 5 on the reagent bottle mouth, to achieve cap.

Preferably, the upper part of the snap joint is equipped with a snap protruding flange stretching outwards.

Preferably, one end of the decap spring 6 is mounted on a holding structure of the reagent bottle, and the other end connects to a hinge pin of the hinge-shaped plate cap 5. When the snap joint 4 is not snapped, due to the traction of the decap spring 6, the hinge-shaped plate cap 5 decaps by turning action of the hinge pin, and the bottle mouth is exposed in decap condition.

Preferably, a side part of the moveable plate is equipped with a bottle cap protruding flange. When the snap joint snaps, the bottle protruding flange covers the snap joint.

Preferably, the decap mechanism 100 and the cap mechanism 200 are fixed on a base 3 of the reagent station 1 respectively, by the fixation base 101 and the supporting base 201.

The decap mechanism 100 comprises a fixation base 101, a supporting plate 102, a first motor 103, a first roller holder 104, a first timing pulley 105, a timing belt 106, a second timing pulley 107, a spindle 108 and a first ejection rod 109.

Preferably, the first roller holder 104 is installed inside the reagent station 1 and is located at the upper part of the reagent bottle.

Preferably, the first motor 103, first roller holder 104, first timing pulley 105, timing belt 106, second timing pulley 107, spindle 108 and first ejection rod 109 are all installed on the supporting plate 102, and the supporting plate 102 is installed on the fixation base 101.

Preferably, the spindle 108 is horizontally inserted into a bearing provided on first roller holder 104, the spindle 108 is provided with a first gear and the second timing pulley 107. The first motor 103 drives the first timing pulley 105 to rotation, the first timing belt 105 connects to the second timing pulley 107 with the timing belt 106 for transmission; the first ejection rod 109 is fixed with a first rack, and the first gear meshes with the first roller holder 104 in vertical direction.

Preferably, the first motor drives the driving unit to move the spindle 108 to rotate with the timing belt, the spindle 108 is provided with a first gear, and the first gear drives a first ejection rod 109 to move upward and downward.

Preferably, by controlling rotation of the first motor, with transmission of the timing belt and the gear rack, the first ejection rod 109 moves upward and downward. When the first ejection rod 109 moves downward, it triggers the protruding flange of the snap joint to complete decap. When the first ejection rod 109 ejects the snap joint of the reagent bottle 2 open, the cap 5 of the reagent bottle 2 is decapped due to the pulling force of the decap spring 6; the first ejection rod 109 moves upward to complete reset.

Preferably, the cap mechanism 200 comprises a supporting base 201, an electric magnet installation seat 202, an electric magnet 203, a knockout plate 204, a puller 205, an extension spring 206, a pop-rivet 207, a limit pin 208, a rocker holder 209, a rocker 210 and a roller baffle 211.

Preferably, the rocker holder 209 is fixed on the supporting base 201. The rocker 210 is installed by matching with the bearing on the rocker holder 209; the electric magnet installation seat 202 is fixed on the supporting base 201, and the electric magnet 203 is installed in the electric magnet installation seat 202. The knockout plate 204 and one end of the rocker 210 are connected together; the other end of the rocker 210 is equipped with the roller baffle 211, and the roller baffle 211 is equipped with roller 11 at the bottom.

Preferably, a drag hook on one end of the extension spring 206 connects to the puller 205 fixed on the knockout plate 204, and another drag hook on the other end connects to the pop-rivet 207 fixed on the supporting base 201. When no power is provided to the electric magnet, the knockout plate 204 falls on the push head 10 of the electric magnet due to the action of the extension spring, and thus maintains the roller baffle on the reagent bottle cap.

When the cap mechanism is not active, the electric magnet 203 is not connected to power. With the pulling force from the extension spring 206, the roller baffle 211 is kept at high position and does not come into contact with cap of the reagent bottle.

When performing cap action, before reaching of the reagent bottle 2, the electric magnet 203 is connected to the power, the push head 10 overcomes the pulling force from the extension spring 206 to push the knockout plate 204 for rotating the rocker 210. The rocker drives the roller baffle 211 to the lowest position, meaning the position of the reagent bottle 2 which is capped. When the capped reagent bottle 2 passes through, the cap of the reagent bottle 2 is blocked by the rocker baffle 211 and makes the snap joint snap due to rolling depression of the roller 11, and thus the bottle is capped.

Preferably, the decap mechanism 100 comprises a first bumper block 110 equipped at one end of first ejection rod 109. This is to prevent the reagent bottle from decapping at excessively high speed, causing any reagent remained on the cap to splash and thus cause pollution and harm.

Preferably, the decap mechanism 100 further comprises a first optical coupling sensor 111 equipped on the supporting base 102 and a first sensor 112 fixed on the spindle 108. During rolling of the spindle, when the first sensor passes through first optical coupling sensor, it blocks the light path of the first optical coupling sensor to trigger a signal of coupling. Thus, the lowering position of the ejection rod can be accurately controlled, meaning that the contact height of the ejection rod and the reagent bottle cap are also controlled.

Preferably, the rocker holder of the cap mechanism is equipped with a limit pin 208, and the limit pin 208 is located under the rocker 204. The limit pin 208 can prevent excessively large spring force from continuously acting on the push head 10 of the electric magnet 203.

Preferably, the decap mechanism further comprises an internal shaft 113, a coupler 114, a motor stand 115, a second motor 116, a second roller holder 117, a second gear 118 and a second ejection rod 121.

Preferably, the roller holder 117 connects to the foresaid first roller holder 104.

Preferably, the second motor 116 is installed on the motor stand 115 fixed on the supporting plate 102. The motor shaft of the second motor 116 connects to one end of the internal shaft 113 with the coupler 114. The other end of the internal shaft 113 matches with bearings of the second roller holder 117 and passes through the hollow spindle 108; the internal shaft 113 is fixed with a second gear 118.

Preferably, the second ejection rod 121 is fixed with a second rack and the second ejection rod 121 is installed on one end of the second gear 118 by gear meshing.

One or more reagent bottles are provided inside the reagent station, on a carousel. When the reagent bottle cap rotates along the reagent station, and when the snap joint protruding flange of the reagent bottle cap in the reagent station is located right under the second ejection rod, the ejection rod moves to complete decapping.

Preferably, the second motor 116 drives the internal shaft 113 with the coupler 114. The second gear 118 provided on the internal shaft 113 drives the second rack of the second ejection rod 121, and thus drives the ejection rod 121 to move upward and downward. Along with control of the motor, the second ejection rod can separately complete decapping of another reagent bottle located at the same radial position of the first reagent bottle; the decap actions of the two reagent bottles are of non-interfering with each other.

Preferably, the decap mechanism further comprises a second optical coupling sensor 119 equipped on the supporting base 102 and a second sensor 112 fixed on the axis of the coupler 114. During rotation of the coupler, the second sensor 112 blocks the second optical coupling sensor to trigger a coupling signal.

Preferably, the decap mechanism further comprises a second bumper block 122 equipped on one end of the second ejection rod 121.

Preferably, the cap mechanism further comprises a bottle cap close test device 220. The bottle cap close test device 220 is fixed on the roller baffle 211 with the close capping optical coupling sensor fixation base 221.

Preferably, the cap mechanism further comprises an optical coupling sensor fixation base 221, a close capping optical coupling sensor 222, a close capping inducer 223, a guide rod 224 and a screw nut 225.

Preferably, the close capping optical coupling sensor 222 is fixed on the close capping optical coupling sensor fixation base 221. The close capping optical coupling sensor fixation base 221 is equipped with vertical holes; the guide rod 224 passes through the holes. The upper part of the guide rod is equipped with two limit screw nuts 225, whose lower part is connected to close capping inducer 223. The close capping inducer guide rod moves upward and downward. When the guide rod is lifted upward to the highest position, the close capping inducer stretches into the close capping optical coupling sensor to block the light path of the close capping optical coupling sensor; when the guide rod is not lifted up, the close capping inducer is located outside the close capping optical coupling sensor, and the light path of the close capping optical coupling sensor is not blocked.

When normal cap or decap of the cap-decap mechanism 200 is not needed for the bottle cap close test device 220, the close capping inducer 223 is located at a low position, meaning that the close capping inducer 223 does not block the light path of the close capping optical coupling sensor, and no signal is triggered.

When, by error, the bottle cap is not closed, the unclosed bottle cap will lift up the close capping inducer 223 to block light path of the close capping optical coupling sensor, and the coupling signal is triggered. The bottle cap continues to pass through, and the close capping inducer 223 returns back to the low position due to its weight, so that it will not block the close capping optical coupling sensor any more. By changes of the close capping optical coupling sensor signal, it can be detected if the bottle cap is currently capped or not, and thus safety and reliability of use are ensured.

In the attached drawings, the reference numbers indicate:
1—reagent station, 2—reagent bottle, 3—base, 4—first snap joint, 5—first hinge-shaped plate cap, 6—decap spring, 7—second snap joint, 8—second hinge-shaped plate cap, 100—decap mechanism, 200—cap mechanism, 101—fixation base, 201—supporting base, 14—snap joint protruding flange, 15—bottle cap protruding flange; 102—supporting plate, 103—first motor, 104—first roller, 105—first timing pulley, 106—timing belt, 107—second timing pulley, 108—gear rod, 109—first ejection rod, 110—first bumper block, 111—first optical coupling sensor, 112—first inducer, 113—middle axis, 114—coupler, 115—motor stand, 116—second motor, 117—second roller holder, 118—second gear, 119—second optical coupling sensor, 120—second inducer, 121—second ejection rod, 122—second bumper block; 202—electric magnet installation seat, 203—electric magnet, 204—pusher, 205—puller, 206—extension spring, 207—pop-rivet, 208—limit pin, 209—risker holder, 210—rocker, 211—roller baffle, 11—roller, 10—push head; 220—bottle cap close capping detection device, 221—close capping optical coupling sensor fixation base, 222—close capping optical coupling sensor, 223—close capping inducer, 224—guide rod, 225—screw nut; 31—light wave emitter, 32—virtual light wave path illustration, 33—light wave receiver.

Many changes, modifications, and variations of the invention may become apparent to those skilled in the art after considering the specification and the accompanying drawings which disclose preferred embodiments thereof. The elements and characteristics described in the various forms of preferred embodiments can be mutually combined. Further implementation details will not be described, as the man skilled in the art is able to carry out the invention starting from the teaching of the above description.

1. An automatic cap-decap mechanism for reagent bottles of an immunoanalyzer apparatus, comprising a decap mechanism and a cap mechanism in reagent station of said immunoanalyzer apparatus, wherein said decap mechanism and said cap mechanism are both configured for operating on a cap of a reagent bottle;
wherein said cap comprises a hinge-shaped plate cap, a snap joint and a decap spring, wherein one side of said hinge-shaped plate cap is hinged on the reagent bottle mouth, and wherein the other side of said hinge-shaped plate cap comprises said snap joint, said snap joint being configured for tightly clamping said hinge-shaped plate cap on the reagent bottle mouth, and wherein one end of said decap spring is mounted on a holding structure of said reagent bottle, and the other end of said decap spring connects to a hinge pin of said hinge-shaped plate cap, so that when the snap joint is not snapped in close position, said decap spring is configured to move said hinge-shaped plate cap so as to expose said bottle mouth in decap condition;
and wherein said decap mechanism comprises a first roller seat located at the upper part of said reagent bottle, and further comprises a rotating rod horizontally inserted into the roller bearings provided on said first roller seat, and further comprises a first motor for timely driving said rotating rod, and further comprises at least one first ejection rod driven by said rotating rod to move upward and downward, said first ejection rod being configured for snapping said snap joint in open position, so as to decap said reagent bottle;
and wherein said cap mechanism comprises a rocker rotatably installed on the roller bearings of a rocker holder, and further comprises a knockout plate connected on one end of said rocker, said knockout plate comprising an electric magnet, said cap mechanism further comprising at least one roller baffle connected on the other end of said rocker, said roller baffle comprising a roller at the bottom, said knockout plate being configured for acting on said rocker under the action of a spring when said electric magnet is not powered, so as to maintain said roller of said roller baffle on said hinge-shaped plate cap, said roller being configured for snapping said snap joint in close position, so as to cap said reagent bottle.

2. The automatic cap-decap mechanism for reagent bottles according to claim 1, wherein said decap mechanism further comprises at least a first bumper block provided at the end of said first ejection rod, said first bumper block being configured to prevent the reagent bottle to be decapped at excessively high speed.

3. The automatic cap-decap mechanism for reagent bottles according to claim 1, wherein said decap mechanism further comprises at least a first optical coupling sensor and a first sensor fixed on said rotating rod, said first sensor being configured for blocking the light path of said first optical coupling sensor, when said first sensor passes through said first optical coupling sensor during rotation of said rotating rod, so as to trigger a signal.

4. The automatic cap-decap mechanism for reagent bottles according to claim 1, wherein said decap mechanism further comprises an internal shaft, a second ejection rod, a second motor for driving said second rotating rod to move upward and downward, said second ejection rod being configured for snapping a second snap joint in open position, so as to decap said reagent bottle.

5. The automatic cap-decap mechanism for reagent bottles according to claim 1, wherein said cap mechanism further comprises a bottle cap close test device fixed on said roller baffle, said cap close test device comprising a close optical coupling sensor and a close sensor, wherein said close sensor is configured for moving upward and downward, to block the light path of said close optical coupling sensor in a high limit position, so as to trigger a signal.

6. The automatic cap-decap mechanism for reagent bottles according to claim 5, wherein said cap close test device further comprises a guide rod, wherein said close optical coupling sensor is fixed on a close optical coupling sensor fixation seat, and wherein said close optical coupling sensor fixation seat comprises vertical holes, said guide rod passing through said vertical holes, and wherein the upper part of said guide rod comprises at least one limit screw nut, and the lower part of said limit screw nut is connected to said close sensor.

7. The automatic cap-decap mechanism for reagent bottles according to claim 1, wherein said reagent station is refrigerated.

8. The automatic cap-decap mechanism for reagent bottles according to claim 1, wherein said reagent station comprises a carousel adapted to rotate one or more reagent bottles under said automatic cap-decap mechanism.

9. An immunoanalyzer apparatus comprising an automatic cap-decap mechanism for reagent bottles according to claim 1.

10. A regent bottle for an immunoanalyzer apparatus, said reagent bottle comprising a cap, said cap comprising a hinge-shaped plate cap, a snap joint and a decap spring, wherein one side of said hinge-shaped plate cap is hinged on the reagent bottle mouth, and wherein the other side of said hinge-shaped plate cap comprises said snap joint, said snap joint being configured for tightly clamping said hinge-shaped plate cap on the reagent bottle mouth, and wherein one end of said decap spring is mounted on a holding structure of said reagent bottle, and the other end of said decap spring connects to a hinge pin of said hinge-shaped plate cap, so that when the snap joint is not snapped in close position, said decap spring is configured to move said hinge-shaped plate cap, so as to expose said bottle mouth in decap condition, wherein said reagent bottle is configured for cap-decap operation in an automatic cap-decap mechanism according to claim 1.

11. A regent bottle according to claim 10, wherein the upper part of said snap joint comprises a snap raised edge which protrudes outwards.

12. A regent bottle according to claim 10, wherein a side part of said hinge-shaped plate cap comprises a bottle cap raised edge, said raised edge being configured for covering said snap joint when said snap joint is in snaps in cap conditions.
